(19) United States
(12) Patent Application Publication
(10) Pub. No.: US 2017/0138562 A1
(43) Pub. Date: May 18, 2017

(54) SYSTEM, DEVICES, AND METHODS FOR ILLUMINATION INCLUDING SOLID-STATE LIGHT EMITTING DEVICES

(71) Applicant: WESTLAND JOAUS TECHNOLOGIES, LLC, Rapid City, SD (US)

(72) Inventors: Boris Western, Rapid City, SD (US); John B. Leonard, Fishers, IN (US); Benjamin R. Rose, New Albany, IN (US); Theodore N. Blowe, Richland, WA (US); Blaine C. Holland, Peru, IN (US); Alexander John Ballinger, Bellevue, WA (US); Paul Holman, Seattle, WA (US)

(21) Appl. No.: 15/318,316

(22) PCT Filed: Jun. 11, 2015
(86) PCT No.: PCT/US15/35355

§ 371 Date: Dec. 12, 2016

Related U.S. Application Data
(60) Provisional application No. 62/011,445, filed on Jun. 12, 2014.

(51) Int. Cl. F21V 3/02; F21V 7/22; F21V 9/16; F21V 31/03; F21K 9/272; H05B 33/08; F21V 29/10; F21K 9/235; F21K 9/232; F21K 9/278; F21V 15/015; H05B 37/02

(52) U.S. Cl. CPC F21V 3/02; F21V 15/015; F21V 7/22; F21V 9/16; F21V 31/03; H05B 37/0272; H05B 37/0236; H05B 33/0854; F21V 29/10; F21K 9/235; F21K 9/232; F21K 9/278; F21K 9/272; H05B 33/0809; F21Y 2115/10

(57) ABSTRACT

The present disclosure s directed to an illumination and networking systems. The illumination and networking systems can include one or more light emitting devices and/or network devices. An illumination and networking component can be operably coupled to at least one of the one or more light emitting devices and the one or more network devices. The illumination and networking systems can include one or more access nodes, bridges, gateways, hubs, range extenders, repeaters, routers, or switches and can include a plurality of solid-state light emitters, circuitry configured to communicate one or more control commands for operating the one or more light emitting devices, and network devices. The illumination and networking system can manage power consumption and/or manage heat generation.

### CROSS-REFERENCE TO RELATED APPLICATION

This application claims the benefit of and priority to U.S. Provisional Patent Application No. 62/011,445 filed Jun. 12, 2014, which is herein incorporated by reference in its entirety.

### SUMMARY

In an aspect, the present disclosure is directed to, among other things, an illumination and networking system. In an embodiment, the illumination and networking system includes one or more light emitting devices. In an embodiment, the illumination and networking system includes one or more network devices. In an embodiment, the illumination and networking system includes an illumination and networking component operably coupled to at least one of the one or more light emitting devices and the one or more network devices. In an embodiment, the illumination and networking system includes one or more access nodes, bridges, gateways, hubs, range extenders, repeaters, routers, or switches. In an embodiment, the illumination and networking system includes a plurality of solid-state light emitters received within a housing. In an embodiment, the illumination and networking system includes circuitry configured to communicate one or more control commands for operating the one or more light emitting devices and the one or more network devices. In an embodiment, the illumination and networking system includes circuitry configured to communicate with at least one client device. In an embodiment, the illumination and networking system includes circuitry configured to negotiate an authorization protocol and to exchange control information with a client device.

In an aspect, the present disclosure is directed to, among other things, a light emitting device. In an embodiment, the light emitting device includes a housing. In an embodiment, the housing includes a light-diffusing structure. In an embodiment, the light-diffusing structure defines an interior environment and an exterior environment. In an embodiment, the light-diffusing structure includes at least a portion configured to selectively allow the passage of heat from the interior environment to the exterior environment and to substantially prevent the passage of moisture from the exterior environment to the interior environment. In an embodiment, the housing includes a light-diffusing structure having a plurality of micropores positioned and dimensioned to allow heat to flow from the interior environment to the exterior environment. In an embodiment, the light emitting device includes a plurality of solid-state light emitters received within the housing. In an embodiment, the light emitting device includes at least one end-cap connector structure.

In an aspect, the present disclosure is directed to, among other things, a security system including at least one light emitting device.

In an aspect, the present disclosure is directed to, among other things, an alert system including at least one light emitting device.

### BRIEF DESCRIPTION OF THE DRAWINGS

FIG. 1 is a perspective view of a light emitting system according to an embodiment.

FIG. 2 is a perspective view of a light emitting system according to an embodiment.

FIG. 3 is a perspective view of a light emitting device according to an embodiment.

FIG. 4A is a perspective view of a light emitting system according to an embodiment,

FIG. 4B is a perspective view of a light emitting system interface according to an embodiment.

FIG. 5 shows logic flow diagrams of a process or method for implementing a security system including a light emitting device according to an embodiment.

FIGS. 6A and 6B shows a logic flow diagram of a process or method for implementing a security system including a light emitting device according to an embodiment.

FIG. 7 shows a logic flow diagram of a process or method for implementing an alert system including a light emitting device according to an embodiment.

FIG. 8 is a perspective view of an illumination and networking device according to an embodiment.

FIG. 9 is a perspective view of an illumination and networking device according to an embodiment.

FIG. 10 is a perspective view of an illumination and networking device according to an embodiment.

FIG. 11 is a perspective view of a monitoring and illumination plant growth system according to an embodiment.

FIG. 12 shows a logic flow diagram of a process or method for implementing a monitoring and light emitting plant growth system according to an embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

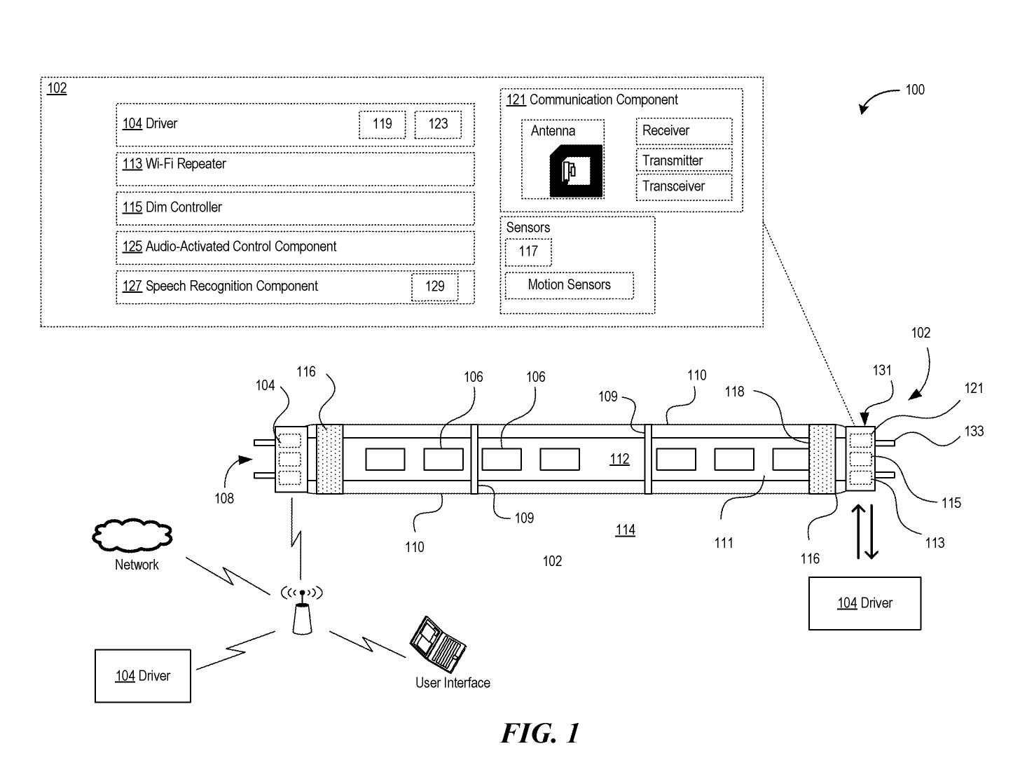

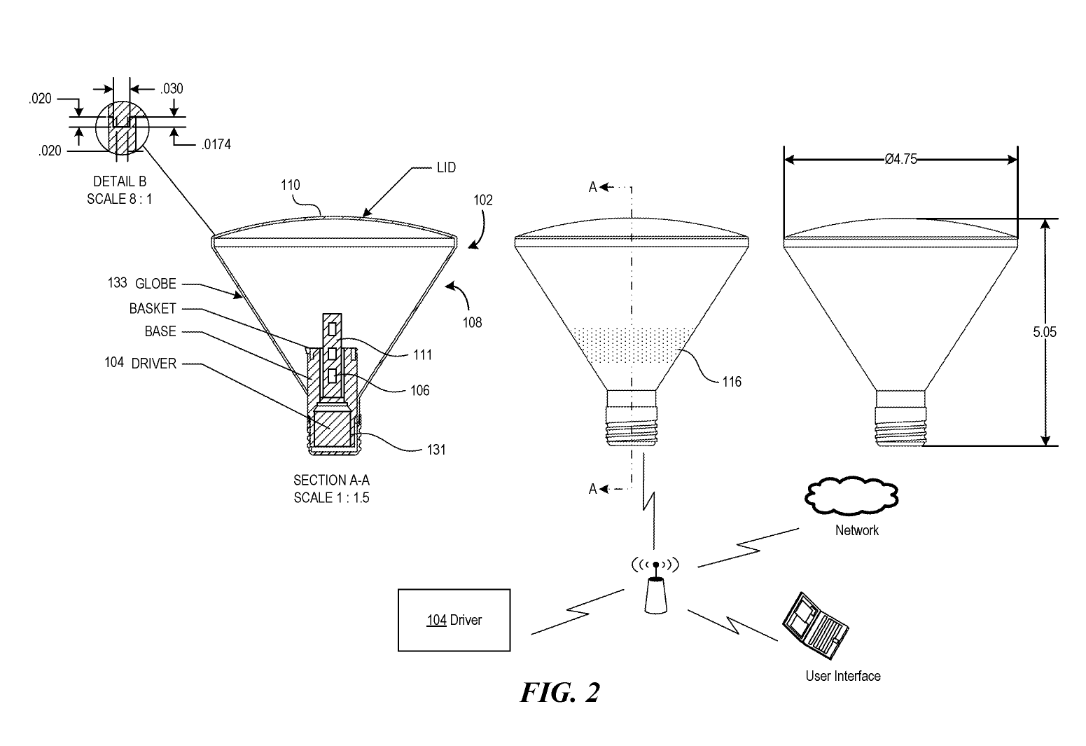

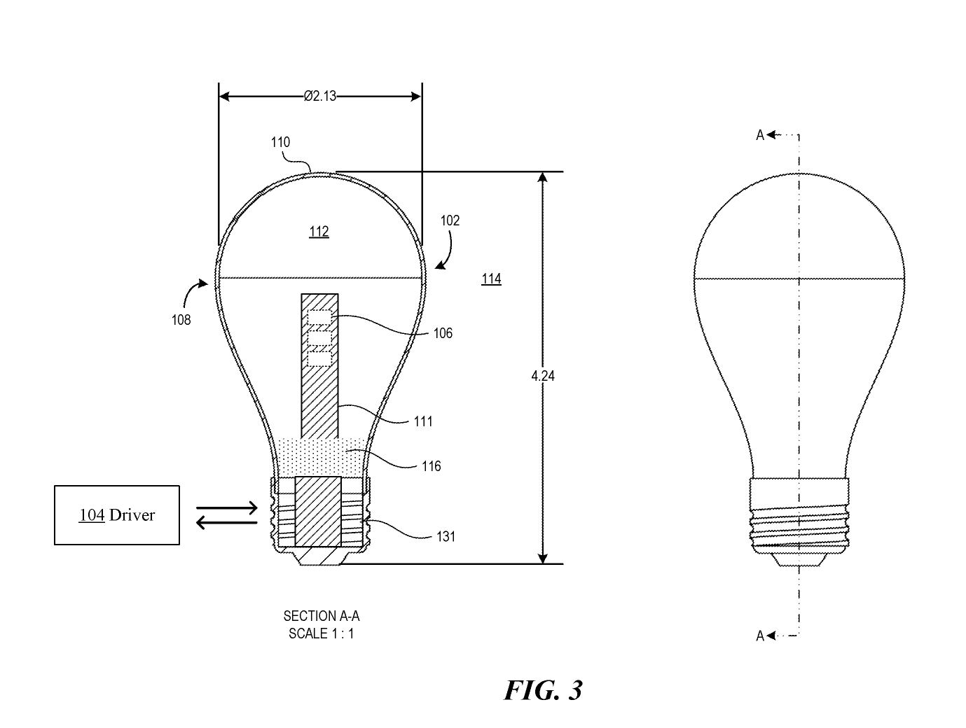

FIGS. 1-3 show a light emitting system 100 in which one or more methodologies or technologies can be implemented such as, for example, a light emitting system 100 having improved performance and efficiency, universal compatibility, high level of brightness, long lifespan, high reliability, or the like.

In an embodiment, the light emitting system 100 includes one or more light emitting devices 102, In an embodiment, the light emitting system 100 includes at least one driver 104 operably coupled to one or more of the light emitting devices 102. In an embodiment, the light emitting system 100 includes at least one remote driver 104.

In an embodiment, the at least one driver 104 is integrated within the light emitting device 102. In an embodiment, the at least one driver 104 includes one or more wired or wireless connections to the light emitting device 102. In an embodiment, the at least one driver 104 is configured to convert power from an alternative current (AC) input into a direct current (DC) output for driving one or more of the light emitting devices 102. For example, in an embodiment, the at least one driver 104 includes circuitry for converting power from an AC input into a DC output for driving one or more of the light emitting devices 102. In an embodiment, the at least one driver 104 includes one or more modules configured to convert power from an AC input into a DC output for driving one or more of the light emitting devices 102. In an embodiment, the DC is used to charge a small energy storage system such as a battery or capacitor such that in the absence of AC, the energy storage device is triggered to release stored energy to keep the lights on and minimal systems operational. In an embodiment, a module includes, among other things, one or more computing devices such as a processor (e.g., a microprocessor), a central processing unit (CPU), a digital signal processor (DSP), an application-specific integrated circuit (ASIC), a field programmable gate array (FPGA), or the like, or any combinations thereof, and can include discrete digital or analog circuit elements or electronics, or combinations thereof. In an embodiment, a module includes one or more ASICs having a plurality of predefined logic components. In an embodiment, a module includes one or more FPGAs, each having a plurality of programmable logic components.

In an embodiment, the at least one driver 104 includes a module having one or more components operably coupled (e.g., communicatively, electromagnetically, magnetically, ultrasonically, optically, inductively, electrically, capacitively, or the like) to each other. In an embodiment, a module includes one or more remotely located components. In an embodiment, remotely located components are operably coupled, for example, via wireless communication. In an embodiment, remotely located components are operably coupled, for example, via one or more receivers, transmitters, transceivers, antennas, or the like. In an embodiment, a drive controller includes a module having one or more routines, components, data structures, interfaces, or the like.

In an embodiment, a module includes memory that, for example, stores instructions or information, For example, in an embodiment, at least one control module includes memory that stores target voltage information, target current amplitude information, target change in voltage of an alternative current information, etc., associated with driving one or more of the light emitting devices 102. Non-limiting examples of memory include volatile memory (e.g., Random Access Memory (RAM), Dynamic Random Access Memory (DRAM), or the like), non-volatile memory (e.g., Read-Only Memory (ROM), Electrically Erasable Programmable Read-Only Memory (EEPROM), Compact Disc Read-Only Memory (CD-ROM), or the like), persistent memory, or the like. Further non-limiting examples of memory include Erasable Programmable Read-Only Memory (EPROM), flash memory, or the like. In an embodiment, the memory is coupled to, for example, one or more computing devices by one or more instructions, information, or power buses.

In an embodiment, a module includes one or more computer-readable media drives, interface sockets, Universal Serial Bus (USB) ports, memory card slots, or the like, and one or more input/output components such as, for example, a graphical user interface, a display, a keyboard, a keypad, a trackball, a joystick, a touch-screen, a mouse, a switch, a dial, or the like, and any other peripheral device. In an embodiment, a module includes one or more user input/output components, user interfaces, or the like, that are operably coupled to at least one computing device (electrical, electromechanical, software-implemented, firmware-implemented, or other control, or combinations thereof) configured to control at least one parameter associated with, for example, driving one or more of the light emitting devices 102.

In an embodiment, a module includes a computer-readable media drive or memory slot that is configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as a magnetic tape, floppy disk, a hard disk drive, a Compact Disc (CD), a Digital Video Disk (DVD), Blu-Ray Disc, a digital tape, a computer memory, or the like, as well as transmission type medium such as a digital or an analog communication medium (e.g., a fiber optic cable, a waveguide, a wired communications link, a wireless communication link (e.g., receiver, transmitter, transceiver, transmission logic, reception logic, etc.). Further non-limiting examples of signal-bearing media include, but are not limited to, DVD-ROM, DVD-RAM, DVD+RW, DVD-RW, DVD-R, DVD-FR, CD-ROM, Super Audio CD, CD-R, CD-FR, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like. In an embodiment, the light emitting device 102 includes Universal Serial Bus (USB) and micro USB ports that provide an end-user the capability to connect hardware such as MICROSOFT™'s XBOX™ Kinect or SONY™'s PLAYSTATION™ camera, which utilize motion capture technology. In an embodiment, these ports can expand the functionality of the light emitting device 102, allowing a user to charge electrical devices, integrate a gaming system, or the like.

In an embodiment, the light emitting system 100 includes a light emitting device 102 having a Wi-Fi repeater 113, a light fidelity (Li-Fi) repeater, or the like. In an embodiment, a Wi-Fi repeater 113 within the light emitting device 102 will extend network reach for residential or commercial use.

In an embodiment, the light emitting system 100 includes at least one driver 104 configured to convert power from an alternating current (AC) input into a direct current (DC) output for driving a plurality of solid-state light emitters 106. In an embodiment, the light emitting system 100 includes at least one driver 104 operably coupled to one or more light emitting device 102. In an embodiment, a light emitting device 102 includes a driver 104 configured to convert power from an alternative current (AC) input into a direct current (DC) output for driving a plurality of solid-state light emitters 106. In an embodiment, the light emitting system 100 includes a dim controller 115 in communication with one or more sensors. For example, in an embodiment, the dim controller 115 is in communication with one or more sensors 117. In an embodiment, the dim controller 115 is in communication with one or more ambient light sensors. In an embodiment, the dim controller 115 is configured to regulate current flow responsive to one or more inputs from the one or more sensors indicative of an environmental lighting condition. In an embodiment, the dim controller 115 is configured to regulate current flow responsive to at least one measure and indicative of change in luminosity. In an embodiment, the dim controller 115 is configured to regulate current flow responsive to at least one measure and indicative of change in line voltage.

In an embodiment, the light emitting device 102 includes one or more driver circuits 119. For example, in an embodiment, the light emitting device 102 includes one or more analog solid-state light emitters 106. In an embodiment, the light emitting system 100 includes a first power regulator component configured to regulate an applied direct current and an applied direct current voltage to the plurality of solid-state light emitters 106.

In an embodiment, the light emitting system 100 includes a communication component 121 configured to communicate with a remote component and to receive control information from the remote component. In an embodiment, the light emitting system 100 includes a communication component 121 configured to communicate with a remote component and to exchange one or more encryption keys with the remote component. In an embodiment, the light emitting system 100 includes a communication component 121 configured to communicate with a client device and to receive control commands from the client device. Non-limiting examples of client devices include a wearable device, a smart device, a computer device, a laptop computer device, a notebook computer device, a desktop computer device, a cell phone device, a tablet device, a managed node device, a wall mounted controller device, an application interface with smart devices, or the like. Further non-limiting examples of client devices include input-output devices, graphical user interfaces, interaction devices, microphones, and the like. In an embodiment, during operation, the light emitting system 100 is controlled via one or more inputs from at least one client device.

In an embodiment, the light emitting system 100 includes a driver component 123 configured to convert power from AC input into DC output for driving the plurality of solid-state light emitters 106. In an embodiment, the light emitting system 100 includes an audio-activated control component 125 operable to receive an audio input and to correlate the audio input to at least one control command for controlling at least one of an applied current or an applied voltage. In an embodiment, the light emitting system 100 includes a speech recognition component 127 including a speech control component 129 configured to correlate speech input to at least one control command for controlling at least one of an applied current or an applied voltage.

Referring to FIGS. 1-3, in an embodiment, a light emitting device 102 includes a housing 108. In an embodiment, the housing 108 defines an interior environment 112 and an exterior environment 114. In an embodiment, the housing 108 can be a geometrical shape, including regular geometric shapes, such as circular, rectangular, triangular, or the like, as well as irregular geometric shapes. In an embodiment, the housing 108 comprises a bullet shape, candle shape, flare shape, global shape, reflector shape, sign shape, or tubular shape. In an embodiment, the housing 108 comprises a standard shape (e.g., A series, ALR series, AR series, B series, BR series, BT series, C series, C-7/F series, CA Series, E series, ED series, F series, G series, Linestra, Linear, MB series, MR series, PAR series. Prims, PS series, R/BR series, RP series, S series, T series, and the like). In an embodiment, the housing 108 comprises a standard shape as define by the American National Standards Institute (ANSI) or the International Electrotechnical Commission (IEC).

In an embodiment, a light emitting device 102 includes a plurality of structural clips 109 sized and dimension to support the plurality of solid-state light emitters 106 within the housing 108.

In an embodiment, a light emitting device 102 is operably coupled to one or more client devices. In an embodiment, a light emitting device 102 is configured to receive and send information to and from one or more client devices. In an embodiment, a light emitting device 102 is configured to send status information, significant event information, sensor information, or the like to one or more client devices. In an embodiment, a light emitting device 102 is configured to receive control commands from one or more client devices. For example, in an embodiment, a light emitting device 102 includes circuitry for receiving control commands from one or more client devices.

In an embodiment, the housing 108 comprises a tubular structure having cross-section with a regular or irregular geometric shape. In an embodiment, the housing 108 comprise or be formed in a variety of shapes and sizes, depending on the end use. In an embodiment, a portion of the housing 108 is formed from plastic, polymers, glasses, resins, and the like. In an embodiment, the housing 108 is formed from recycled materials and is recyclable itself. In an embodiment, materials such as plastic, polymers, resins, etc., allows the housing 108 to be shatter proof for environments where a glass housing 108 is not practical.

In an embodiment, a light emitting device 102 includes a plurality of solid-state light emitters 106. In an embodiment, a light emitting device 102 includes a plurality of solid-state light emitters 106 received within the housing 108. In an embodiment, a light emitting device 102 includes solid-state light emitters 106 affixed to a stem 111.

Common light fixture designs mount numerous light-emitting-diodes (LEDs) in close proximity, creating a need for large heat sinks. In an embodiment, the stem 111 is dimensioned and configured to hold the plurality of solid-state light emitters 106 within the light emitting device 102 in a configuration that maximizes light output. In an embodiment, the stem 111 is dimensioned and configured to hold the plurality of solid-state light emitters 106 within the light emitting device 102 in a configuration that manages the heat generated by the light emitting device 102. For example, in an embodiment, the plurality of solid-state light emitters 106 in a spaced-apart configuration to maximize heat diffusion. In an embodiment, a light emitting device 102 includes multiple solid-state light emitters 106 that are mounted in spaced-apart patterns, allowing for simple heat management. In an embodiment, the plurality of solid-state light emitters 106 are in a spaced-apart configuration to maximize heat dissipation. In an embodiment, the stem 111 is joined to a base 131 via mechanical and electrical junction or connectors that provide structure and electrical function.

In an embodiment, the plurality of solid-state light emitters 106 includes one or more optical emitters. Non-limiting examples of optical emitters include edge emitters, laser diodes, light-emitting diodes, multipolar radiation of quantum emitters, superradiant optical emitters, surface emitters, vertical cavity light emitters, and the like. Further non-limiting examples of optical emitters include blue emitters, broad-spectrum emitters, full spectrum emitters, infrared emitters, multi-spectrum emitters, near blue emitters, ultraviolet emitters, white broad-spectrum emitters, white light emitters, and the like. In an embodiment, the plurality of solid-state light emitters 106 includes one or more InAlGaN (Indium Aluminium Gallium Nitride) optical emitters. In an embodiment, the plurality of solid-state light emitters 106 includes one or more light-emitting diodes. Non-limiting examples of light-emitting diodes includes organic light-emitting diodes, polymer light-emitting diodes, polymer phosphorescent light-emitting diodes, microcavity light-emitting diodes, high-efficiency light-emitting diodes, and the like.

In an embodiment, the plurality of solid-state light emitters 106 comprises one or more solid-state light bulbs. In an embodiment, the plurality of solid-state light emitters 106 comprises a housing 108 structure that encloses one or more solid-state lighting chips including, for example, one or more light emitting diodes (LEDs), organic light emitting diodes (OLED), and the like.

In an embodiment, the housing 108 is dimensioned and configured to fit into fixtures currently used by customers such as lamps, ceiling fixtures, up-light cans, down-light cans or other fixtures designed to hold light bulbs. In an embodiment, the light emitting device 102 is configured and dimensioned to comport with the standards defined by the American National Standards Institute (ANSI) and International Electrotechnical Commission (IEC) publications.

In an embodiment, a light emitting device 102 includes at least one end-cap-connector structure. Non-limiting examples of end-cap-connector structures include A series connector structures, ALR series connector structures. AR series connector structures, B series connector structures, BR series connector structures, BT series connector structures, C series connector structures, C-7/F series connector structures, CA Series connector structures, E series connector structures, ED series connector structures, F series connector structures, G series connector structures, Linestra connector structures, Linear connector structures, MB series connector structures, MR series connector structures, PAR series connector structures, Prims connector structures, PS series connector structures, R/BR series connector structures, RP series connector structures, S series connector structures, T series connector structures, and the like. Further non-limiting examples of end-cap-connector structures include Edison screws, MOG light bulb connector structures, base connector structures 131, end prongs 133, G12 connector structures, and the like. In an embodiment, the at least one end cap connector structure comprises a standard light bulb base 131 type (e.g., Edison screw, MOG, end prong, G12, and the like).

In an embodiment, the housing 108 includes a light-diffusing structure 110. In an embodiment, the light-diffusing structure 110 defines an interior environment 112 and an exterior environment 114. In an embodiment, a light emitting device 102 is configured to diffuse light efficiently while maintaining effective heat management. For example, in an embodiment, at least a portion of the light-diffusing structure 110 is configured to selectively allow the passage of water vapor from the interior environment 112 to the exterior environment 114 and to substantially prevent the passage of air and water from the exterior environment 114 to the interior environment 112.

In an embodiment, at least a portion of the light-diffusing structure 110 is formed from high-density polymer fibers. In an embodiment, at least a portion of the light-diffusing structure 110 is formed from high-density polyethylene fibers that are substantially randomly distributed and nondirectional. In an embodiment, at least a portion of the light-diffusing structure 110 is formed from TYVEK® (sold by DUPONT™).

In an embodiment, at least a portion of the light-diffusing structure 110 is formed from high-density polyethylene fibers having a length ranging from about 0.5 micrometers to about 10 micrometers. In an embodiment, at least a portion of the light-diffusing structure 110 includes an etched surface, a plurality of facets, and a plurality of grooves, and combinations thereof. In an embodiment, at least a portion of the light-diffusing structure 110 includes a sandblasted region. In an embodiment, at least a portion of the light-diffusing structure 110 includes a surface treatment by a mechanical or chemical means. For example, in an embodiment, at least a portion of the light-diffusing structure 110 includes a surface treatment that is deposited, etched, sintered, or otherwise applied to the light-diffusing structure 110 to form a plurality of microstructures that cause light to diffuse. For example, lithographic techniques can be used to form microstructures onto a surface of the light-diffusing structure 110. The lithographic process for forming microstructures can include for example, applying a resist film (e.g., spin-coating a photoresist film) onto the substrate, exposing the resist with an image of a microstructure layout (e.g., the geometric pattern), heat treating the resist, developing the resist, transferring the layout onto the substrate, and removing the remaining resist. Transferring the layout onto the light-diffusing structure 110 can include for example, using techniques such as subtractive transfer, etching, additive transfer, selective deposition, impurity doping, ion implantation, and the like.

In an embodiment, at least a portion of the light-diffusing structure 110 is altered by a mechanical process. For example, in an embodiment, at least a portion of the light-diffusing structure 110 includes a sandblasted surface. In an embodiment, at least a portion of the light-diffusing structure 110 includes a surface that has been randomized by roughing. For example, in an embodiment, at least a portion of the light-diffusing structure 110 includes a surface that has been sanded. In an embodiment, the randomized roughing of the surface ensures a high rate of diffusion. In an embodiment, at least a portion of the light-diffusing structure 110 is treated with a frosted glaze that adds to the diffusion rate of the light source giving the appearance that a portion of the housing 108 is glowing. In an embodiment, this glow is desirable to consumers as this is the appearance to which they are accustomed. In an embodiment, where an omni-directional light source is not required, at least a portion of the housing 108 is lined internally with a layer of flashspun, high-density polyethylene fiber to optimally reflect the light in the direction desired. In an embodiment, the housing 108 is also pierced in specific locations to create micropores 116 for the heat to flow out of the housing 108 via thermal convection currents. In an embodiment, to ensure that a light emitting device 102 remains weather safe, the micropores 116 are covered with a layer of flash spun, high-density polyethylene fibers to allow for heat, air, etc., to flow out, while providing a moisture lock.

In an embodiment, at least a portion of the light-diffusing structure 110 includes one or more transparent materials, translucent material, or light-transmitting material, and combinations or composites thereof. Non-limiting examples of optically transparent, translucent, or light-transmitting materials include one or more of acetal copolymers, acrylic, glass, AgBr, AgCl, Al₂O₃, GeAsSe glass, BaF₂, CaF₂, CdTe, AsSeTe glass, Csl, diamond, GaAs, Ge, ITRAN materials, KBr, thallium bromide-Iodide, LiF, MgF₂, NaCl, polyethylene, Pyrex, Si, SiO₂, ZnS, ZnSe, thermoplastic polymers, and thermoset polymers, and combinations and composites thereof. Further non-limiting examples of optically transparent, translucent, or light-transmitting materials include one or more of acrylonitrile butadaine styrene polymers, cellulose, epoxy resins, ethylene butyl acrylate, ethylene tetrafluoroethylene, ethylene vinyl alcohol, fluorinated ethylene propylene, furan, nylon, phenolic, poly[2,2,4-trifluoro-5-trifluoromethoxy-1, 3-dioxole-co-tetrafluoroethylene], poly[2,2-bistrifluoromethyl-4,6-difluoro-1,3-dioxole-co-tetrafluoroethylene], poly[2,3-(perfluoroalkenyl)perfluorotetrahydrofuran], polyacrylonitrile butadiene styrene, polybenzimidazole, polycarbonate, polyester, polyetheretherketone, polyetherimide, polyethersulfone, polyethylene, polyimide, polymethyl methacrylate, polynorbornene, polyperfluoroalkoxyethylene, polystyrene, polysulfone, polyurethane, polyvinyl chloride, polyvinylidene fluoride, diallyl phthalate, thermoplastic elastomers, transparent polymers, and vinyl esters, and combinations and composites thereof.

In an embodiment, at least a portion of the light-diffusing structure 110 includes a solid frost coating. In an embodiment, at least a portion of the light-diffusing structure 110 includes a light scattering coating. In an embodiment, at least a portion of the light-diffusing structure 110 includes a light diffusing coating. In an embodiment, at least a portion of the light-diffusing structure 110 includes a sandblasted effect optic film. In an embodiment, at least a portion of the light-diffusing structure 110 includes a light diffuser film.

In an embodiment, at least a portion of the light-diffusing structure 110 includes a phosphor coating. In an embodiment, at least a portion of the light-diffusing structure 110 includes a reflective coating.

In an embodiment, at least a portion of the light-diffusing structure 110 includes one or more regions having average roughness (Ra) of about 1.5 micrometers or less. In an embodiment, at least a portion of the light-diffusing structure 110 includes one or more regions having an average peak count (PC) of about 100 peaks/centimeter or more.

In an embodiment, a method of managing heat generation of the light emitting device 102 includes perforating a portion of the housing 108 with a plurality of micropores 116. In an embodiment, the micropores 116 are configured and dimensioned to allow heat and air to flow freely through areas where heat has accumulated without letting in moisture. In an embodiment, the micropores 116 are covered with selectively permeable synthetic material 118 that also serves as a moisture barrier.

In an embodiment, the housing 108 includes a light-diffusing structure 110 having a plurality of micropores 116 positioned and dimensioned to allow heat to flow from the interior environment 112 to the exterior environment 114. In an embodiment, the housing 108 includes a light-diffusing structure 110 having a protective structure. For example, in an embodiment, the housing 108 includes a light-diffusing structure 110 having a protective structure configured to allow the passage of heat from an interior environment 112, through the micropores 116, to an exterior environment 114, In an embodiment, the housing 108 includes a light-diffusing structure 110 having a protective structure configured to prevent the passage of air and water from the exterior environment 114, through the micropores 116, to the interior environment 112. In an embodiment, a light emitting device 102 includes a plurality of micropores 116 proximate the at least one end cap connector structure, In an embodiment, the plurality of micropores 116 includes a protective structure 118. For example, in an embodiment, the plurality of micropores 116 includes a protective structure 118 configured to selectively allow the passage of water vapor from an interior environment 112, through the micropores 116, to an exterior environment 114 and to substantially prevent the passage of air and water from the exterior environment 114, through the micropores 116, to the interior environment 112. In an embodiment, the protective structure is optically enhanced for light dispersion via mechanical, chemical or optical (LASER) means such that the material is embossed or etched to create multi-dimensional structures on the surface of the material with the purpose of scattering or dispersing the light in an even pattern that maximizes dispersion while limiting light loss.

In an embodiment, the protective structure 118 comprises high-density polyethylene fibers that are substantially randomly distributed and nondirectional. In an embodiment, the protective structure 118 comprises high-density polyethylene fibers having a length ranging from about 0.5 micrometers to about 10 micrometers. In an embodiment, the protective structure 118 comprises TYVEK® (sold by DUPONT™).

In an embodiment, at least a portion of the light-diffusing structure 110 includes at least a first region and a second region, the second region having a roughness factor that is different from the first region. In an embodiment, at least a portion of the light-diffusing structure 110 includes at least a first region and a second region, the second region having a transmittance that is different from the first region. In an embodiment, at least a portion of the light-diffusing structure 110 includes at least a first region and a second region, the second region having a reflectivity that is different from the first region.

In an embodiment, a light emitting device 102 includes a base 131, a stem 111, and a globe 133. In an embodiment, the base 131 makes connection to the electric source. In an embodiment, the solid-state light emitters 106 are affixed to the stem 111. In an embodiment, the globe 133 forms part of a protective housing 108 that diffuses the light, protects the light source from the elements, and is integral for our heat management system.

In an embodiment, a light emitting system 100 including one or more light emitting devices 102 forms part of a security system, an alarm system, a commercial building security system, a home security system, an automated security system, or the like. For example, during operation, a security system 400 includes at least one light emitting device 102 having one or more components that acquire information regarding a security incident such as a possible intruder or security breach. In an embodiment, the security system 400 includes one or more components that acquire information regarding a security incident, In an embodiment, the security system 400 includes one or more components that implement a response protocol based on information regarding security incident.

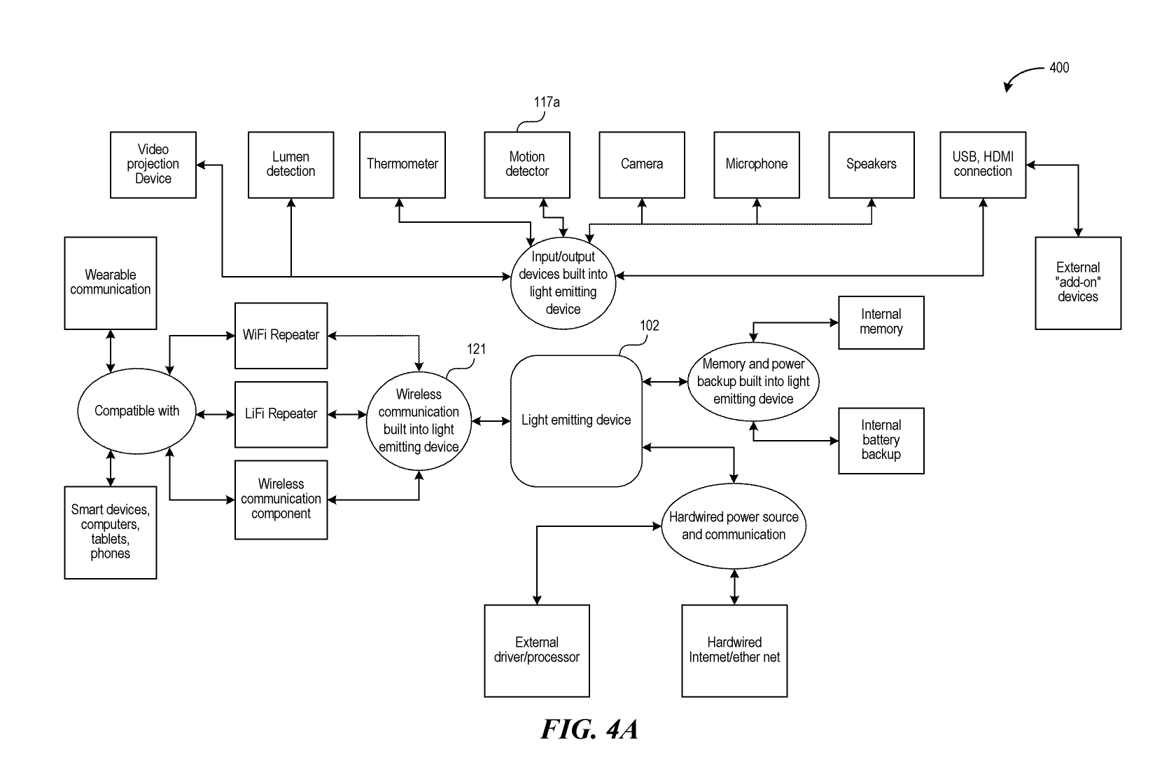

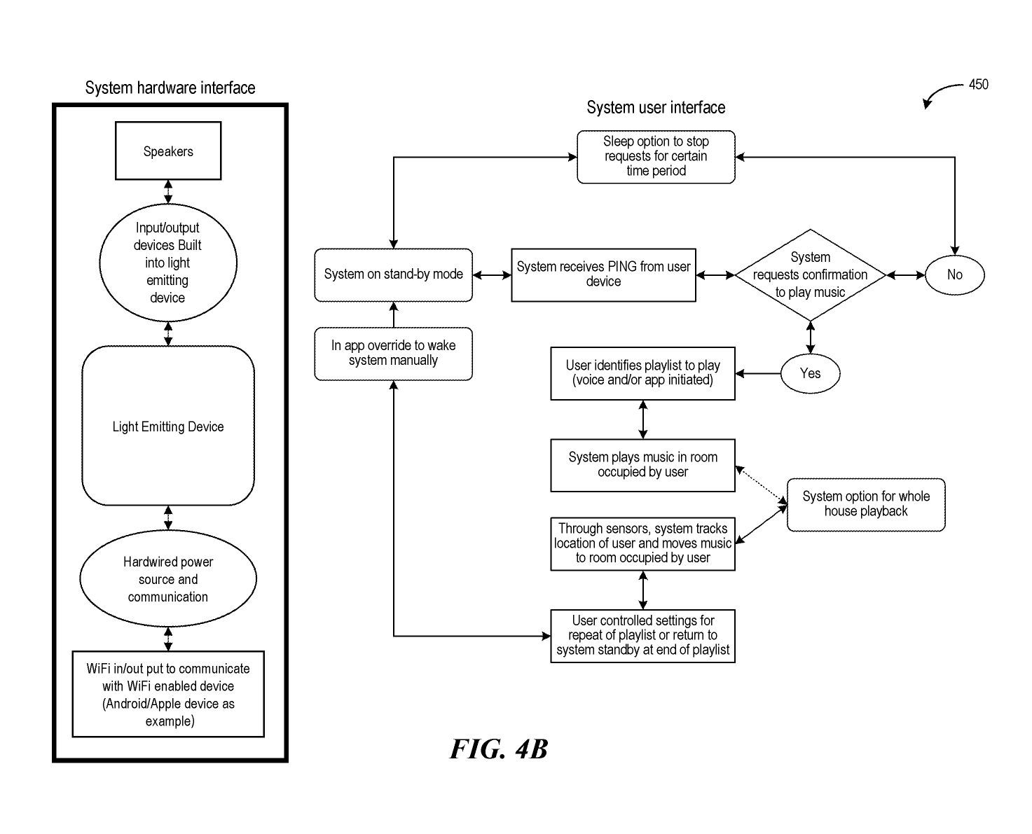

FIGS. 4A and 4B shows a security system 400 in which one or more methodologies or technologies can be implemented such as, for example, a commercial security system for a building, an automated security, an alarm system or the like. In an embodiment, the security system 400 includes one or more light emitting devices 102. In an embodiment, the security system 400 includes at least one light emitting device 102 having a communication component 121 configured to communicate with one or more remote components. For example, in an embodiment, the security system 400 includes a light emitting device 102 having a communication component 121 configured to communicate with a remote enterprise device, a network device, a cloud server, a client device, or the like. In an embodiment, the security system 400 includes at least one light emitting device 102 having one or more sensors. Non-limiting examples of sensors include image sensors, lumen detection sensors, temperature sensors, electromagnetic energy sensors (e.g., optical sensors, infrared sensors, radiation sensors, and the like), motion sensors, acoustic sensors, and the like. Further non-limiting examples of sensors include one or more optic devices (e.g., photodetectors, imagers, charge-coupled device (CCD) detectors, complementary metal-oxide-semiconductor (CMOS) detectors, cameras, imagers, and the like.). In an embodiment, the security system 400 includes one or more light emitting devices 102 communicatively coupled to at least one client device. Non-limiting examples of client devices include a wearable device, a smart device, a computer device, a laptop computer device, a notebook computer device, a desktop computer device, a cell phone device, a tablet device, a managed node device, a wall mounted controller device, an application interface with a smart device, or the like. Further non-limiting examples of client devices include input-output devices, graphical user interfaces, interaction devices, microphones, and the like. Further non-limiting examples of client devices include televisions, display devices, microwave ovens, microwave ovens having a display, refrigerators, refrigerators having a display, audio equipment, or the like that are in communication with a light emitting device 102. In an embodiment, during operation, the security system 400 is controlled via one or more inputs from at least one client device. In an embodiment, during operation, the security system 400 communicates one or more outputs to at least one client device. In an embodiment, the security system 400 is activated remotely. In an embodiment, the security system 400 is on stand-by mode. In an embodiment, the security system 400 includes power-save mode.

In an embodiment, the security system 400 includes one or more sensors 117. In an embodiment, the security system 400 includes one or more sensors 117 for monitoring one or more parameters, detecting environmental conditions or the like. For example, the security system 400 includes one or more image sensors, lumen detection sensors, temperature sensors, electromagnetic energy sensors (e.g., optical sensors, infrared sensors, radiation sensors, and the like), motion sensors, acoustic sensors, and the like. In an embodiment, the security system 400 includes one or more optic devices (e.g., photodetectors, imagers, charge-coupled device (CCD) detectors, complementary metal-oxide-semiconductor (CMOS) detectors, cameras, imagers, and the like.).

In an embodiment, the security system 400 includes one or more connected technologies and methodologies. In an embodiment, connected technologies and methodologies enable a light emitting device 102 to connect one or more client devices, enterprise devices, remote devices, and the like to manage, receive, utilize, deliver, and/or perform similar functions with the information. In an embodiment, connected technologies and methodologies enable users to customize the functionality of one or more light emitting device 102. For example, connected technologies and methodologies enable users to manage, receive, deliver, utilize, and the like with user-specific protocols associated with a light emitting device 102.

In an embodiment, connected technologies and methodologies enable users to connect a light emitting device 102 via a client device to one or more client devices, enterprise devices (e.g., a network device, a server, a cloud server, a retailer server device, retailer network device, a computer device, a laptop computer device, a notebook computer device, a desktop computer device, a mobile device, a tablet device, a managed node device, and the like), remote devices, and the like. Non-limiting examples of connected technologies and methodologies can be found in U.S. Pat. No. 8,856,748 (Issued Oct. 7, 2014) (which is incorporated herein by reference).

FIG. 4B shows a system interface 450 in which one or more methodologies or technologies can be implemented such as, for example, implementing stand-by modes for a light emitting system 100 including one or more a light emitting devices 102.

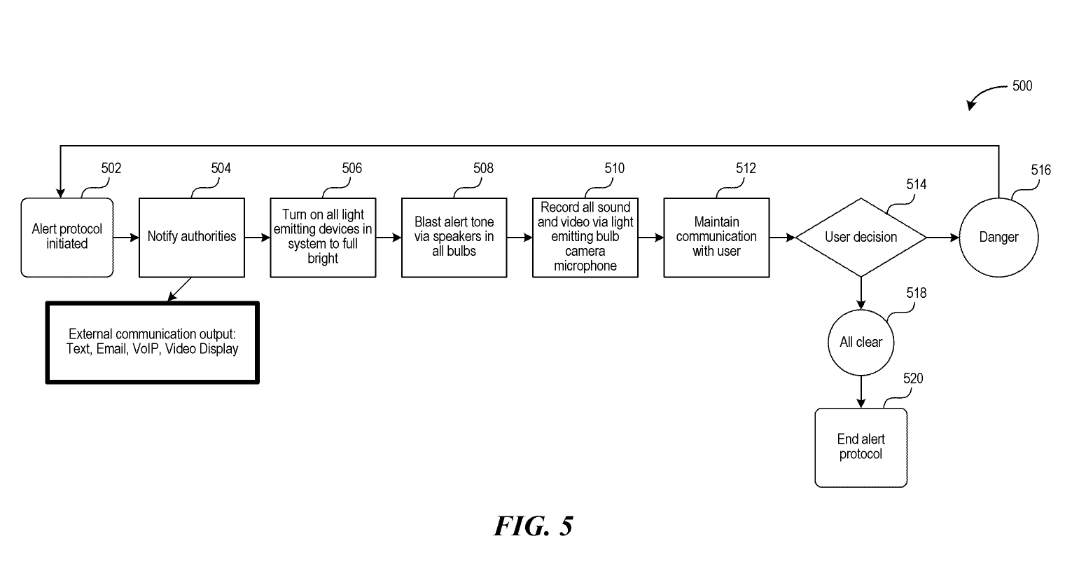

FIG. 5 shows a logical flow diagram of a process or method 500 for implementing a security system 400 employing a light emitting device 102 according to an embodiment. At 502, the process or method 500 includes initiating an alert protocol. In an embodiment, initiating the alert protocol includes activating at least one sensor associated with a light emitting device 102, In an embodiment, initiating the alert protocol includes communicating an alert to at least one client device. At 504, the process or method 500 includes generating a notification regarding a system status, a security incident, a sensor measurement, or the like. In an embodiment, generating the notification includes communicating with an enterprise network regarding a system status, a security incident, a sensor measurement, or the like. In an embodiment, generating the notification includes communicating with authorities. In an embodiment, generating the notification includes communicating information indicative that a violation of a security policy, a breach of a security safeguard, or the like. In an embodiment, generating the notification includes activating an automated security information and event management device. In an embodiment, generating the notification includes generating a text message, an electronic communication, an e-mail, a virtual display, a video display, a voice over internet protocol (VoIP) communication, or the like has occurred. At 606, the process or method 500 includes activating one or more light emitting devices 102 in security system 400 to a target setting (e.g. full bright, all lights on, every other light on, etc.), At 608, the process or method 500 includes activating at least one notification or alert component. In an embodiment, activating the at least one notification or alert component includes activating at least one alarm, alert tone, audio warning, or the like.

At 510, the process or method 500 includes recording ambient noise, ambient sounds, room noises, voices, or the like. In an embodiment, recording ambient noise, ambient sounds, room noises, or the like includes activating at least one microphone or recording device. In an embodiment, the process or method 500 includes capturing one or more images. In an embodiment, capturing the one or more images includes activating an imager, camera, or the like onboard the one or more light emitting devices 102. At 512, the process or method 500 includes communicating with a remote client device regarding security system 400 information. In an embodiment, communicating with a remote client device regarding security system 400 information includes communicating captured images, audio, video, or the like. At 514, the process or method 500 includes a user's decisions in determining security status information based on one or more sensor inputs. At 516, determining security status includes determining whether an intruder is still present based on one or more sensor inputs. At 518, determining security status includes determining whether the security incident has been resolved. At 520, the process or method 500 includes deactivating the alert protocol.

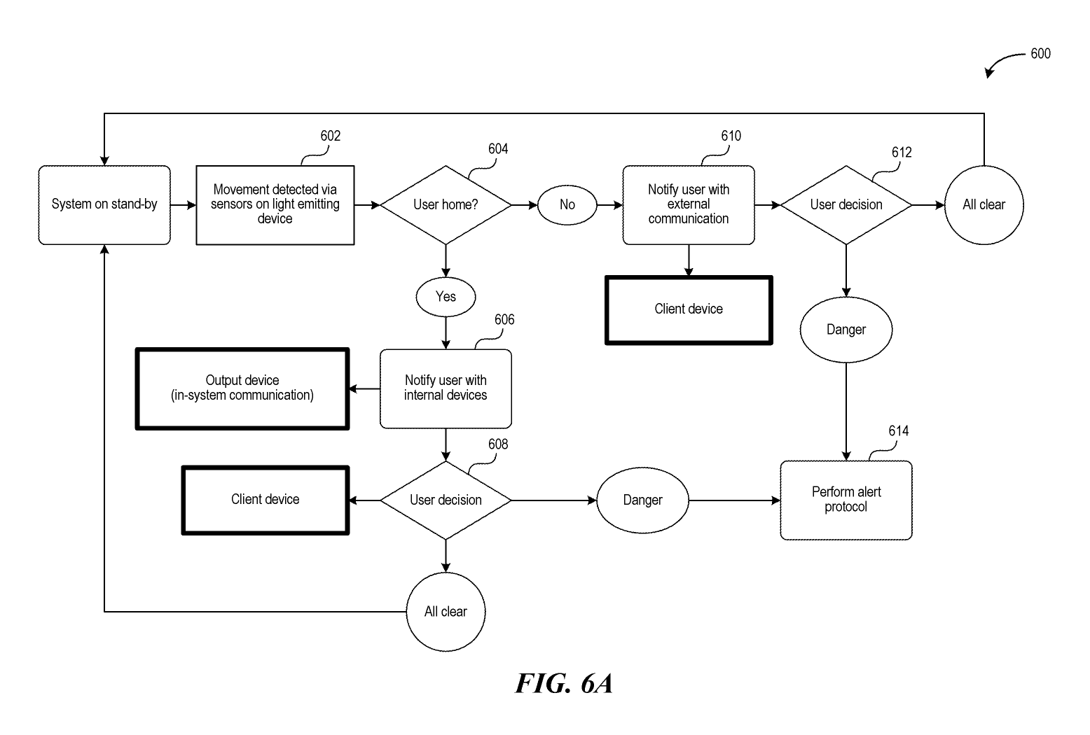

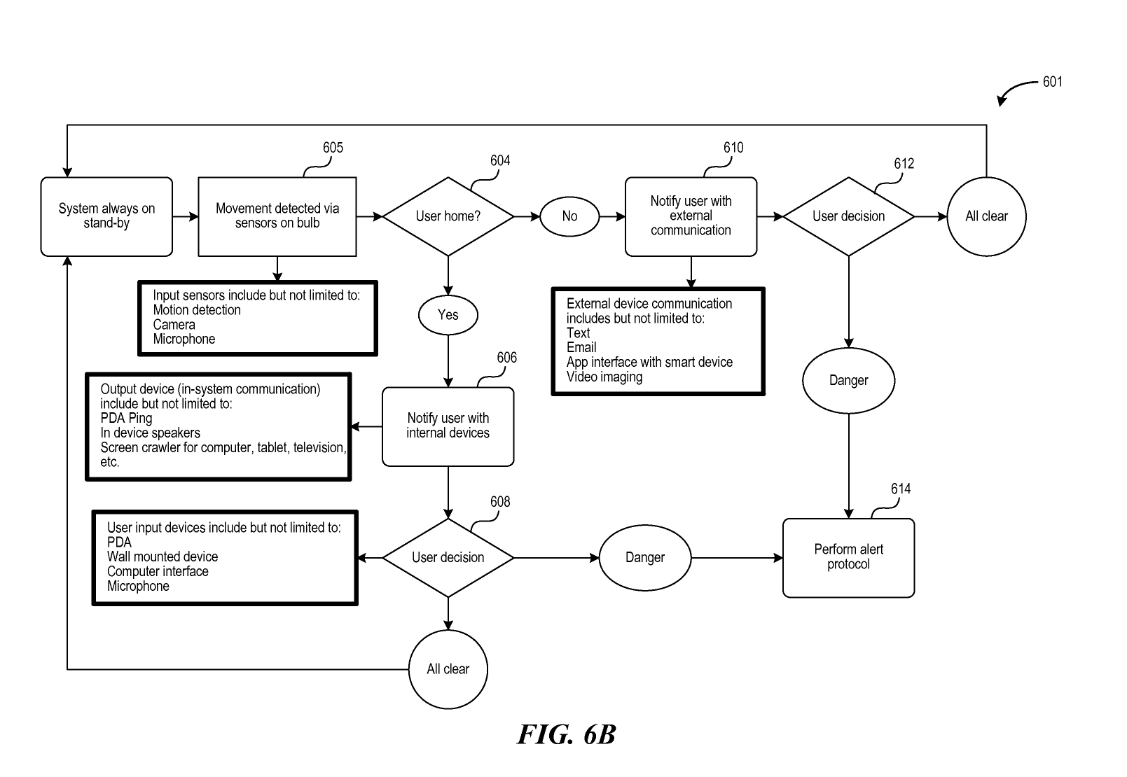

FIGS. 6A and 6B show a logical flow diagram of a process or method 600 for implementing a security system 400 employing at least one light emitting device 102 according to an embodiment. At 602, during operation, one or more sensors associated with a light emitting device 102 detect moving objects, animals, people, etc. At 604, the process or method 600 includes determining whether a user is occupying the premises based on information generated from an embodiment of security system 400. At 606, the process or method 600 includes notifying a user of a security incident using an in-system communication device, an in-system display, an alarm, or the like. In an embodiment, notifying a user of a security incident includes communicating security incident information to a client device. In an embodiment, notifying a user of a security incident includes generating an alert tone, sending an electronic communication, activating a screen crawler for a client device, or the like. At 608, the process or method 600 includes implementing a response protocol responsive to one or more user inputs. In an embodiment, implementing a response protocol includes activating a response protocol responsive to one or more user inputs from a client device. At 610, the process or method 600 includes notifying a user of a security incident. In an embodiment, notifying a user of a security incident includes communicating security incident information, such as captured images, audio, video, or the like, to a remote client device. In an embodiment, notifying a user of a security incident includes communicating captured images, audio, video, or the like. At 612, the process or method 600 includes implementing a response protocol responsive to one or more user inputs from a remote client device. At 614, the process or method 600 includes activating an alert protocol, such as generating an alert tone, sending an electronic communication, activating a screen crawler for a client device, or the like,

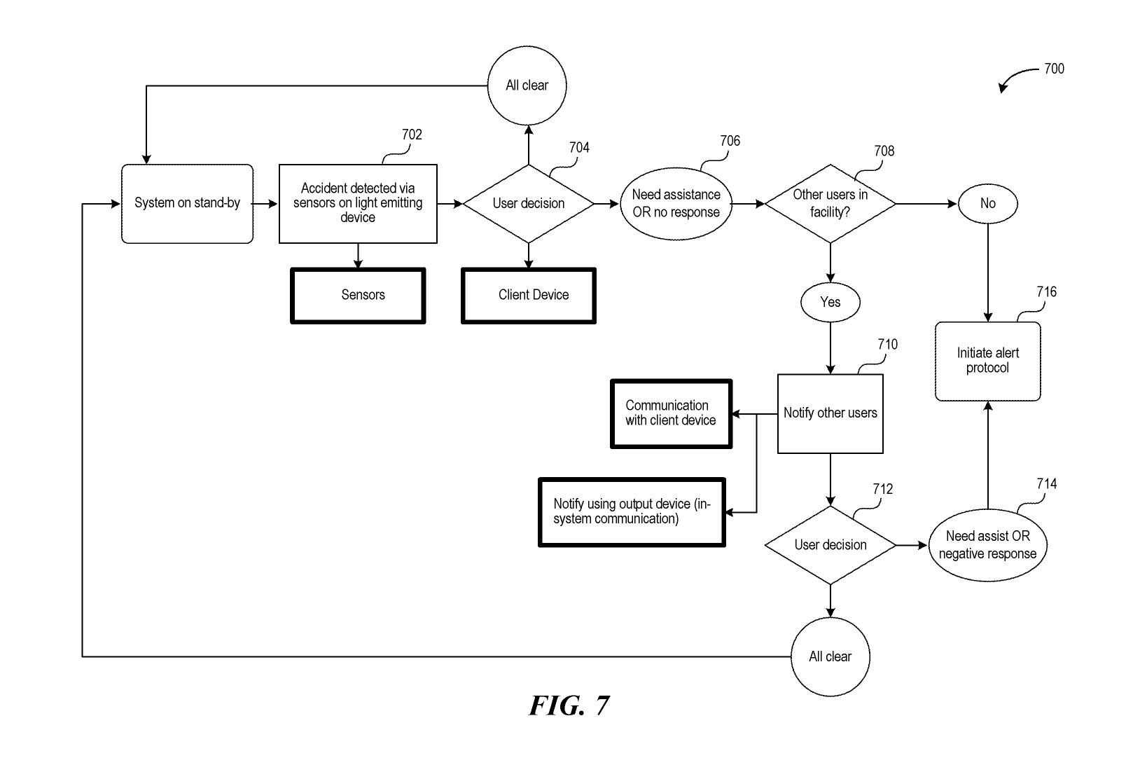

FIG. 7 shows a logical flow diagram of a process or method 700 for implementing an alert system employing a light emitting device 102 according to an embodiment. At 702, the process or method 700 includes identifying whether a significant event has occurred or is occurring responsive to one or more inputs from at least one sensor. In an embodiment, identifying whether a significant event has occurred or is occurring includes detecting an event based on one or more inputs from at least one sensor. In an embodiment, identifying whether a significant event has occurred or is occurring includes identifying an object based on one or more acquired images. In an embodiment, identifying whether a significant event has occurred or is occurring includes determining whether an accident has occurred based on one or more inputs from at least one sensor. In an embodiment, identifying whether a significant event has occurred or is occurring includes determining whether a person has been in an accident based on one or more acquired images.

At 704, the process or method 700 includes determining a user decision based on a communication with a client device. In an embodiment, determining a user decision based on a communication with a client device includes determining whether an accident has occurred based on one or more inputs from a client device. At 706, the process or method 700 includes determining whether a user requires assistance. In an embodiment, determining whether a user requires assistance includes determining whether a user requires assistance based on a communication with a client device. In an embodiment, the process or method 700 includes initiating a response protocol in the absence of an input indicative of a user response. At 708, the process or method 700 includes determining whether there are any other users or occupants in a facility. In an embodiment, determining whether there are any other users or occupants includes receiving a communication from a client device associated with a user or occupant and determining whether there are any other users or occupants based on the communication. In an embodiment, determining whether there are any other users or occupants includes acquiring sensor information and determining whether there are any other users or occupants based on the acquired sensor information.

At 710, the process or method 700 includes generating a notification that a significant event has occurred or is occurring based on a determination that other users or occupants are present in a facility. In an embodiment, generating a notification that a significant event has occurred or is occurring includes sending a communication to a client device associated with a user or occupant present in a facility. At 712, the process or method 700 includes determining whether a significant event has occurred or is occurring responsive to one or more inputs from a client device associated with a user or an occupant. At 714, the process or method 700 includes determining whether a person associated with a significant event needs assistance. In an embodiment, determining whether a person associated with a significant event needs assistance includes comparing one or more communications from a client device to threshold criteria information. At 716, the process or method 700 includes initiating an alert protocol. In an embodiment, initiating the alert protocol includes sending a communication to a client device based on a determination that a significant event has occurred or is occurring. In an embodiment, initiating the alert protocol includes sending a communication to a client device based on a determination that a significant event has occurred and a person associated with a significant event needs assistance. In an embodiment, initiating the alert protocol includes activating the at least one notification, such as an alarm, alert tone, audio warning, or the like.

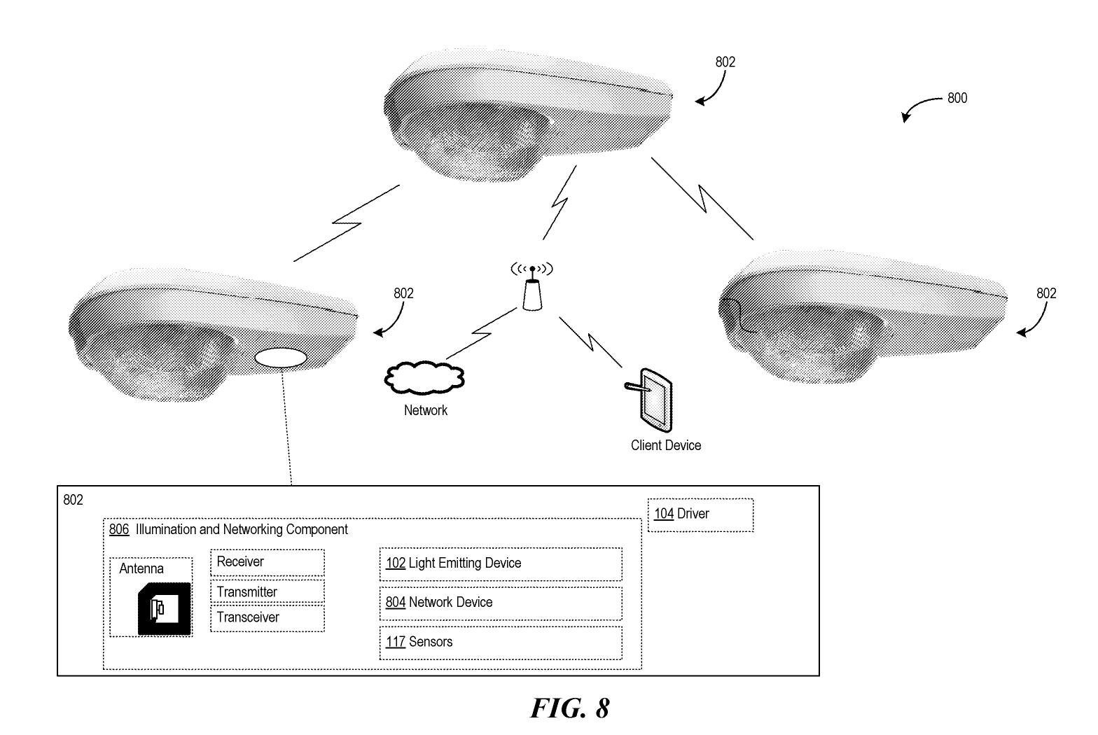

FIG. 8 shows an illumination and networking system 800 in which one or more methodologies or technologies can be implemented such as, for example, an illumination and networking system 800 forming part of a street lighting system, or the like. In an embodiment, the illumination and networking system 800 includes one or more light emitting devices 802. In an embodiment, the illumination and networking system 800 includes at least one driver 104 operably coupled to one or more of the light emitting devices 802. In an embodiment, the illumination and networking system 800 includes at least one remote driver 104. In an embodiment, the illumination and networking system 800 includes at least one internal driver 104. In an embodiment, one or more components include circuitry configured to control a voltage of a current from a power line to power the light emitting devices 802.

In an embodiment, a driver 104 controls voltage/current from a source to power the light emitting devices 802. In an embodiment, a computer device receives various environmental inputs to determine light output. In an embodiment, the illumination and networking system 800 includes circuitry to establish a communications gateway to a network. In an embodiment, one or more light emitting devices 802 form part of a street light configured to receive and send data. In an embodiment, one or more light emitting devices 802 form part of a street light system configured to receive and send, among other things, traffic information, weather information, and security camera information. In an embodiment, information is communicated to cloud via a network component. In an embodiment, light emitting device 802 includes circuitry configured to establish a communicated link to a cloud, an enterprise network, a network component, or the like. In an embodiment, information stored or generated by the illumination and networking system 800 can be accessed via one or more client devices. For example, in an embodiment, information can be accessed by users, city managers, private owners of parking lots, private roads (anywhere exterior illumination is installed), etc., via one or more client devices. In an embodiment, fiber optic or other wired networking cable is operably coupled to the light emitting device 802 along with the AC power from the utility company. In an embodiment, light emitting device 802 includes circuitry to generate a networking signal is sent out via WiFi, LiFi, or other wireless protocol or radio wave wireless protocol to allow users to access the network from a device of their choosing. In an embodiment, access includes whole house and building solutions for high speed wireless network access.

In an embodiment, light emitting device 802 includes one or more sensors. In an embodiment, light emitting device 802 includes one or more input devices including for example, a lumen detection device, a thermometer, a motion detector, a camera, a weather station, or the like In an embodiment, light emitting device 802 takes the form of an exterior illumination device including a wireless communication component. In an embodiment, light emitting device 802 includes one or more WA repeaters, LiFi repeaters, wireless communication devices using Bluetooth, RF, IR, zigbee, Z-wave, etc. In an embodiment, a network cable and AC power cable are operably coupled to a controller associated with the light emitting device 802.

In an embodiment, the illumination and networking system 800 includes one or more network devices 804. In an embodiment, the illumination and networking system 800 includes an illumination and networking component 806 operably coupled to at least one of the one or more light emitting devices 802 and the one or more network devices 804. In an embodiment, the illumination and networking system 800 includes one or more access nodes, bridges, gateways, hubs, range extenders, repeaters, routers, or switches. In an embodiment, the illumination and networking system 800 includes a plurality of solid-state light emitters received within a housing. In an embodiment, the illumination and networking system 800 includes circuitry configured to communicate one or more control commands for operating the one or more light emitting devices 802 and the one or more network devices 804. In an embodiment, the illumination and networking system 800 includes circuitry configured to communicate with at least one client device. In an embodiment, the illumination and networking system 800 includes circuitry configured to negotiate an authorization protocol and to exchange control information with a client device.

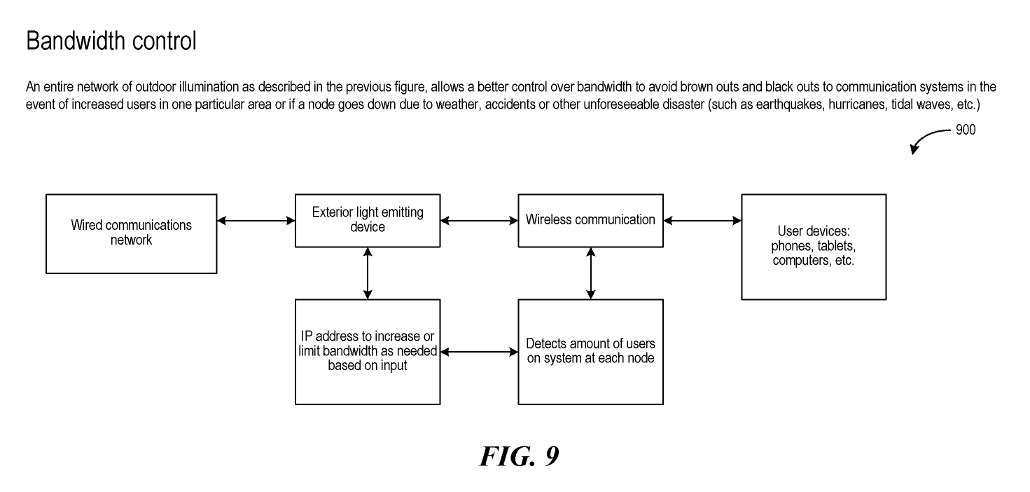

Referring to FIG. 9, in an embodiment, a network 900 including a plurality of light emitting devices 802 forming part of an outdoor illumination is configured to provide control over bandwidth to avoid brown outs and black outs to communications systems in the event of increased users in one particular area or if a node goes down due to weather, accidents or other unforeseeable disaster (such as earth quakes, hurricanes, tidal waves etc.).

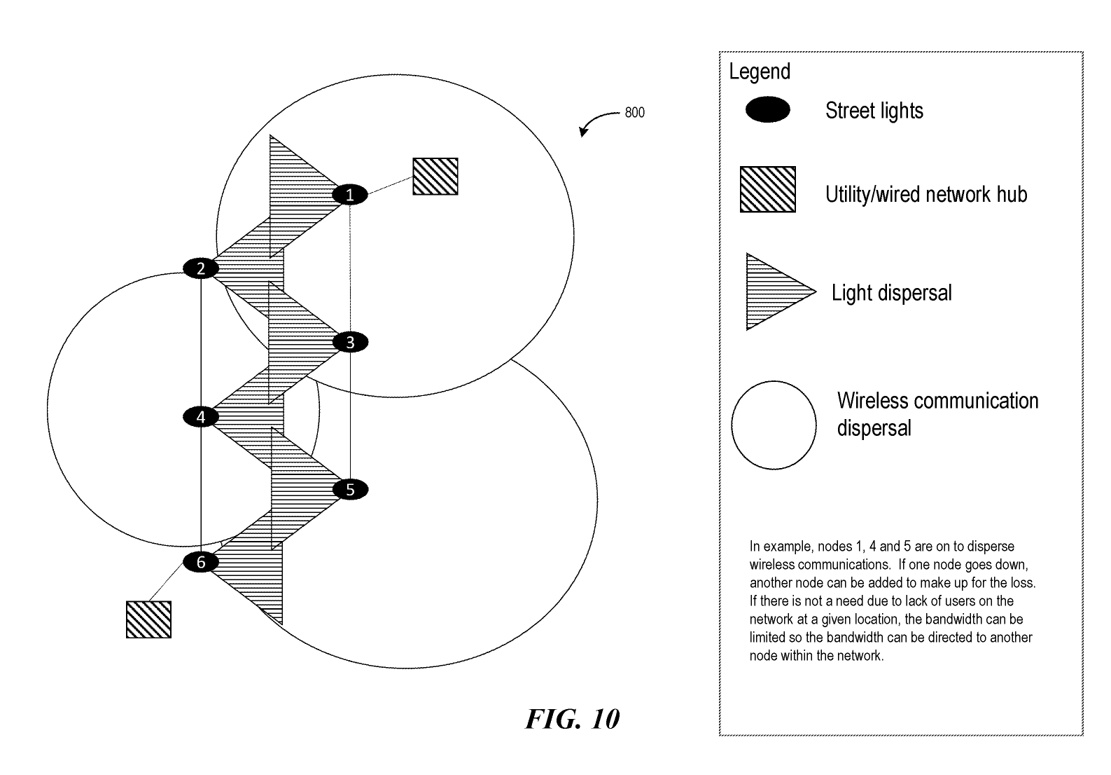

Referring to FIG. 10, in an embodiment, the illumination and networking system 800 includes a plurality of nodes. For example, in an embodiment, the networking system 800 includes a plurality of nodes on to disperse wireless communications. In an embodiment, if one node goes down, another node can be added to make up for the loss. In an embodiment, if demand is down due to lack of users on the network at a given location, the bandwidth can be limited so the bandwidth can be directed to another node within the network.

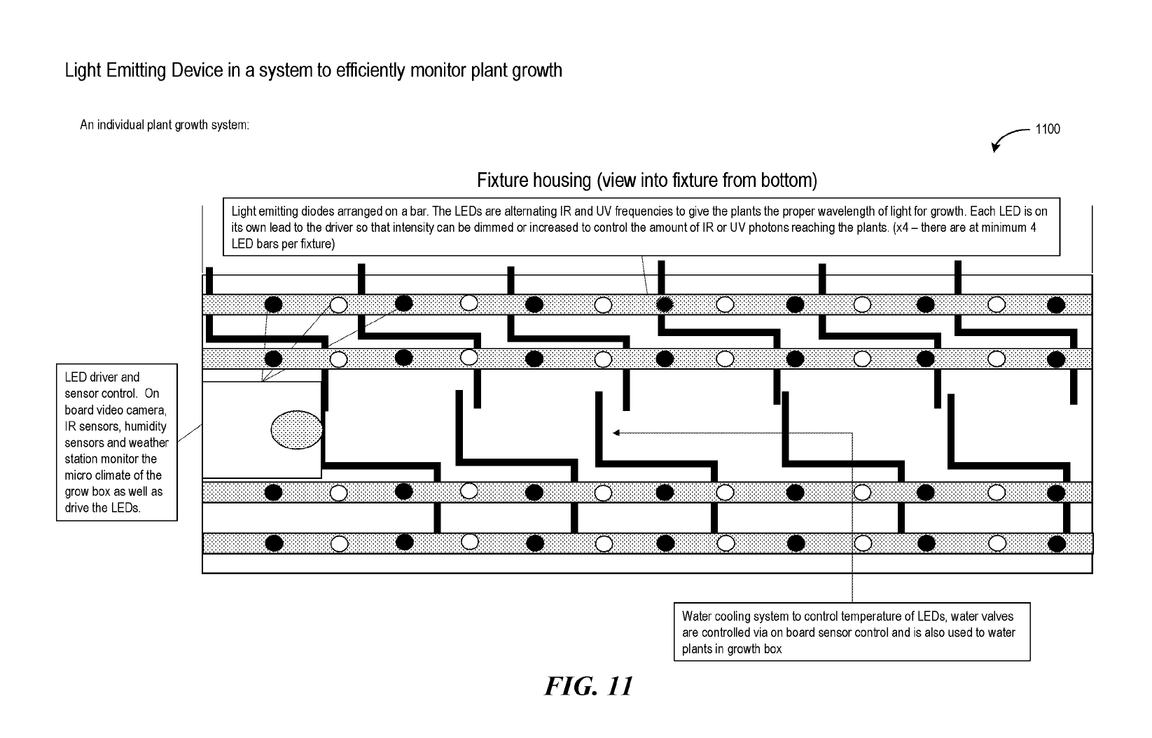

FIG. 11 shows a monitoring and illumination plant growth system in which one or more methodologies or technologies can be implemented such as, for example, monitoring and illuminating a greenhouse or agricultural enterprise.

In an embodiment, the monitoring and illumination plant growth system 1100 includes one or more light emitting devices 102 arranged on a bar. In an embodiment, the light emitting devices 102 are alternating infrared (IR) and ultraviolet (UV) frequencies to give the plants the proper wavelength(s) of light for growth. In an embodiment, each light emitting device 102 is on its own lead to the driver so that intensity can be dimmed or increased to control the amount of IR or UV photons reaching the plants. In an embodiment, there are at minimum 4 LED bars per fixture. For example, in an embodiment, each LED is on its own lead to the driver so that intensity can be dimmed or increased to control the amount of IR or UV photons reaching the plants.

In an embodiment, the monitoring and illumination plant growth system 1100 includes a driver and sensor control. In an embodiment, the light emitting devices 102 includes an on board video camera, IR sensors, humidity sensors and weather station monitor. In an embodiment, the monitoring and illumination plant growth system 1100 is configured to monitor the micro climate of a grow box, greenhouse, planter, etc., as well as to drive the one or more light emitting devices 102. In an embodiment, the monitoring and illumination plant growth system 1100 includes a water-cooling system to control the temperature of one or more light emitting devices 102, water valves controlled via on board sensor control, etc. to water plants in growth box, greenhouse, planter, etc.

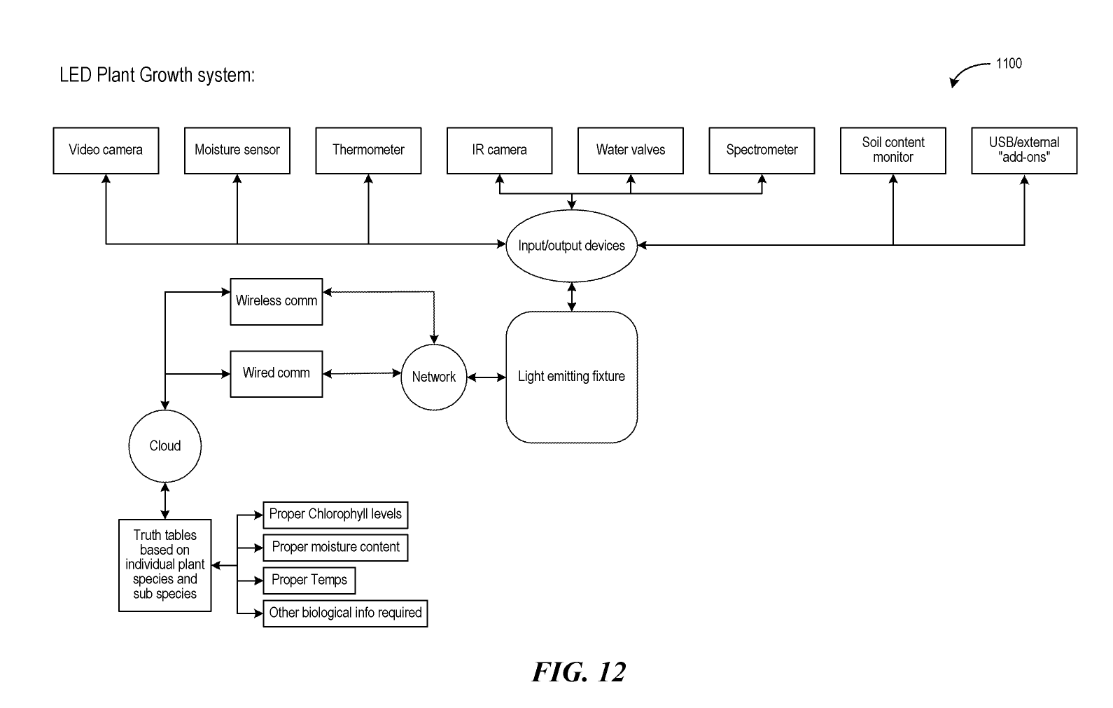

Referring to FIG. 12, in an embodiment, the monitoring and illumination plant growth system 1100 includes one or more sensors. For example, the monitoring and illumination plant growth system 1100 includes one or more sensors for monitoring one or more parameters, detecting environmental conditions or the like. For example, the monitoring and illumination plant growth system 1100 includes one or more image sensors, lumen detection sensors, temperature sensors, electromagnetic energy sensors (e.g., optical sensors, infrared sensors, radiation sensors, and the like), motion sensors, acoustic sensors, water level sensors, spectrometers, and the like. In an embodiment, the monitoring and illumination plant growth system 1100 includes one or more optic devices (e.g., photodetectors, imagers, charge-coupled device (CCD) detectors, complementary metal-oxide-semiconductor (CMOS) detectors, cameras, imagers, and the like.).

In an embodiment, the monitoring and illumination plant growth system 1100 includes one or more soil content monitors, moisture sensors, and the like. In an embodiment, the monitoring and illumination plant growth system 1100 includes one or more water valve controllers.

In an embodiment, the monitoring and illumination plant growth system 1100 is operably coupled to one or more client devices. In an embodiment, the monitoring and illumination plant growth system 1100 is configured to send and receive information associated with monitoring and illumination plants. In an embodiment, connected technologies and methodologies enable the monitoring and illumination plant growth system 1100 to connect to one or more client devices, enterprise devices (e.g., a network device, a server, a cloud server, a retailer server device, retailer network device, a computer device, a laptop computer device, a notebook computer device, a desktop computer device, a mobile device, a tablet device, a managed node device, and the like), remote devices, and the like. Non-limiting limiting examples of connected technologies and methodologies can be found in U.S. Pat. No. 8,856,748 (Issued Oct. 7, 2014) (which is incorporated herein by reference).

The claims, description, and drawings of this application may describe one or more of the technologies described herein in operational/functional language, for example as a set of operations to be performed by a computer. Such operational/functional description in most instances can be specifically configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions are representative of static or sequenced specifications of various hardware elements. This is true because tools available to implement technical disclosures set forth in operational/functional formats—tools in the form of a high-level programming language (e.g., C, lava, visual basic), etc.), or tools in the form of Very high speed Hardware Description Language (“VIDAL,” which is a language that uses text to describe logic circuits—)—are generators of static or sequenced specifications of various hardware configurations. This fact is sometimes obscured by the broad term “software,” but, as shown by the following explanation, what is termed “software” is a shorthand for a massively complex interchanging/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, available at the website en.wikipedia.org/wiki/High-level programming language (as of Jun. 5, 2012, 21:00 GMT). In order to facilitate human comprehension, in many instances, high-level programming languages resemble or even share symbols with natural languages. See, e.g., Wikipedia, Natural language, available at the website en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct” (e.g., that “software”—a computer program or computer-programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In an embodiment, if a high-level programming language is the tool used to implement a technical disclosure in the form of functions/operations, it can be understood that, far from being abstract, imprecise, “fuzzy,” or “mental” in any significant semantic sense, such a tool is instead a nearly incomprehensibly precise sequential specification of specific computational—machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory devices, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, available at the website en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, available at the website en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeroes and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, available at the website en.wikipedia.org/wiki/Instructions_per_second (as of Jun. 5, 2012, 21:04 GMT).

Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mutt,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most humans. Accordingly, any such operational/functional technical descriptions may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description, Charles Babbage, for example, constructed the first computer out of wood and powered it by cranking a handle.

Thus, far from being understood as an abstract idea, a functional/operational technical description should be recognized as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

At least a portion of the devices or processes described herein can be integrated into an information processing system. An information processing system generally includes one or more of a system unit housing, a video display device, memory, such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), or control systems including feedback loops and control motors (e.g., feedback for detecting position or velocity, control motors for moving or adjusting components or quantities). An information processing system can be implemented utilizing suitable commercially available components, such as those typically found in data computing/communication or network computing/communication systems.

The state of the art has progressed to the point where there is little distinction left between hardware and software implementations of aspects of systems; the use of hardware or software is generally (but not always, in that in certain contexts the choice between hardware and software can become significant) a design choice representing cost versus efficiency tradeoffs. Various vehicles by which processes or systems or other technologies described herein can be effected (e.g., hardware, software, firmware, etc., in one or more machines or articles of manufacture), and the preferred vehicle will vary with the context in which the processes, systems, other technologies, etc., are deployed. For example, if an implementer determines that speed and accuracy are paramount, the implementer may opt for a mainly hardware or firmware vehicle; alternatively, if flexibility is paramount, the implementer may opt for a mainly software implementation that is implemented in one or more machines or articles of manufacture; or, yet again alternatively, the implementer may opt for some combination of hardware, software, firmware, etc. in one or more machines or articles of manufacture. Hence, there are several possible vehicles by which the processes, devices, other technologies, etc., described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. In an embodiment, optical aspects of implementations will typically employ optically-oriented hardware, software, firmware, etc., in one or more machines or articles of manufacture.

The herein described subject matter sometimes illustrates different components contained within, or connected with, different other components. It is to be understood that such depicted architectures are merely examples, and that in fact, many other architectures can be implemented that achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled, ” to each other to achieve the desired functionality, and any two components capable of being so associated can also be viewed as being “operably coupleable,” to each other to achieve the desired functionality. Specific examples of operably coupleable include, but are not limited to, physically mateable, physically interacting components, wirelessly interactable, wirelessly interacting components, logically interacting, logically interactable components, etc.

In an embodiment, one or more components may be referred to herein as “configured to,” “configurable to,” “operable/operative to,” “adapted/adaptable,” “able to,” “conformable/conformed to,” etc. Such terms (e.g., “configured to”) can generally encompass active-state components, or inactive-state components, or standby-state components, unless context requires otherwise.

The foregoing detailed description has set forth various embodiments of the devices or processes via the use of block diagrams, flowcharts, or examples. Insofar as such block diagrams, flowcharts, or examples contain one or more functions or operations, it will be understood by the reader that each function or operation within such block diagrams, flowcharts, or examples can be implemented, individually or collectively, by a wide range of hardware, software, firmware in one or more machines or articles of manufacture, or virtually any combination thereof. Further, the use of “Start,” “End,” or “Stop” blocks in the block diagrams is not intended to indicate a limitation on the beginning or end of any functions in the diagram. Such flowcharts or diagrams may be incorporated into other flowcharts or diagrams where additional functions are performed before or after the functions shown in the diagrams of this application. In an embodiment, several portions of the subject matter described herein is implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software and or firmware would be well within the skill of one of skill in the art in light of this disclosure. In addition, the mechanisms of the subject matter described herein are capable of being distributed as a program product in a variety of forms, and that an illustrative embodiment of the subject matter described herein applies regardless of the particular type of signal-bearing medium used to actually carry out the distribution. Non-limiting examples of a signal-bearing medium include the following: a recordable type medium such as a floppy disk, a hard disk drive, a Compact Disc (CD), a Digital Video Disk (DVD), a digital tape, a computer memory, etc.; and a transmission type medium such as a digital or an analog communication medium (e.g., a fiber optic cable, a waveguide, a wired communications link, or a wireless communication link (e.g., transmitter, receiver, transmission logic, reception logic, etc.), etc.).

While particular aspects of the present subject matter described herein have been shown and described, it will be apparent to the reader that, based upon the teachings herein, changes and modifications can be made without departing from the subject matter described herein and its broader aspects and, therefore, the appended claims are to encompass within their scope all such changes and modifications as are within the true spirit and scope of the subject matter described herein. In general, terms used herein, and especially in the appended claims (e.g., bodies of the appended claims) are generally intended as “open” terms (e.g., the term “including” should be interpreted as “including but not limited to, ” the term “having” should be interpreted as “having at least,” the term “includes” should be interpreted as “includes but is not limited to, ” etc.). Further, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations, ” without other modifiers, typically means at least two recitations, or two or more recitations). Furthermore, in those instances where a convention analogous to “at least one of A, B, and C, etc.” is used, in general such a construction is intended in the sense of the convention (e.g., “a system having at least one of A, B, and C” would include but not be limited to systems that have A alone, B alone, C alone, A and B together, A and C together, B and C together, and/or A, B, and C together, etc.), In those instances where a convention analogous to “at least one of A, B, or C, etc.” is used, in general such a construction is intended in the sense of the convention (e.g., “ a system having at least one of A, B, or C” would include but not be limited to systems that have A alone, B alone, C alone, A and B together, A and C together, B and C together, and/or A, B, and C together, etc.). Typically a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, the operations recited therein generally may be performed in any order. Also, although various operational flows are presented in a sequence(s), it should be understood that the various operations may be performed in orders other than those that are illustrated, or may be performed concurrently. Examples of such alternate orderings includes overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A light emitting device, comprising:
a housing including a light-diffusing structure, the light-diffusing structure defining an interior environment and an exterior environment, the light-diffusing structure having at least a portion configured to selectively allow the passage of heat from the interior environment to the exterior environment and to substantially prevent the passage of moisture from the exterior environment to the interior environment;
a plurality of solid-state light emitters received within the housing; and
at least one end cap connector structure.

2. The light emitting device of claim 1, wherein at least a portion of the light-diffusing structure is formed from high-density polymer fibers.

3. The light emitting device of claim 1, wherein at least a portion of the light-diffusing structure is formed from high-density polyethylene fibers that are substantially randomly distributed and nondirectional.

4. The light emitting device of claim 1, wherein at least a portion of the light-diffusing structure is formed from TYVEK®.

5. The light emitting device of claim 1, wherein at least a portion of the light-diffusing structure is formed from high-density polyethylene fibers having a length ranging from about 0.5 micrometers to about 10 micrometers.

6. The light emitting device of claim 1, wherein at least a portion of the light-diffusing structure includes at least one of an etched surface, a plurality of facets, and a plurality of grooves, or combinations thereof.

7. The light emitting device of claim 1, wherein at least a portion of the light-diffusing structure includes a sandblasted region.

8. The light emitting device of claim 1, wherein at least a portion of the light-diffusing structure includes a mechanically altered surface or a chemically altered surface.

9. The light emitting device of claim 1, wherein at least a portion of the light-diffusing structure includes one or more transparent materials, translucent materials, or light-transmitting materials, or combinations or composites thereof.

10. The light emitting device of claim 1, wherein at least a portion of the light-diffusing structure includes a solid frost coating.

11. The light emitting device of claim 1, wherein at least a portion of the light-diffusing structure includes a light scattering coating.

12. The light emitting device of claim 1, wherein at least a portion of the light-diffusing structure includes a light diffusing coating.

13. The light emitting device of claim 1, wherein at least a portion of the light-diffusing structure includes a sandblasted effect optic film.

14. The light emitting device of claim 1, wherein at least a portion of the light-diffusing structure includes a light diffuser film.

15. The light emitting device of claim 1, wherein at least a portion of the light-diffusing structure includes one or more regions having average roughness (Rₐ) of about 1.5 micrometers or less.

16. The light emitting device of claim 1, wherein at least a portion of the light-diffusing structure includes one or more regions having an average peak count (PC) of about 100 peaks/centimeter or more.

17. The light emitting device of claim 1, wherein at east a portion of the light-diffusing structure includes a phosphor coating.

18. The light emitting device of claim 1, wherein at least a portion of the light-diffusing structure includes a reflective coating.

19. The light emitting device of claim 1, wherein at least a portion of the housing includes a reflective coating.

20. The light emitting device of claim 1, the housing further comprising:
a plurality of micropores positioned and dimensioned to allow heat to flow from the interior environment to the exterior environment.

21. The light emitting device of claim 20, wherein the plurality of micropores includes a protective structure configured to selectively allow the passage of water vapor from the interior environment, through the micropores, to the exterior environment and to substantially prevent the passage of moisture from the exterior environment, through the micropores, to the interior environment.

22. The light emitting device of claim 21, wherein the protective structure comprises high-density polyethylene fibers that are substantially randomly distributed and nondirectional.

23. The light emitting device of claim 21, wherein the protective structure comprises TYVEK®.

24. The light emitting device of claim 21, wherein the protective structure comprises high-density polyethylene fibers having a length ranging from about 0.5 micrometers to about 10 micrometers.

25. The light emitting device of claim 1, wherein at least a portion of the light-diffusing structure includes at least a first region and a second region, the second region having a roughness factor that is different from the first region.

26. The light emitting device of claim 1, wherein at least a portion of the light-diffusing structure includes at least a first region and a second region, the second region having a transmittance that is different from the first region.

27. The light emitting device of claim 1, wherein at least a portion of the light-diffusing structure includes at least a first region and a second region, the second region having a reflectivity that is different from the first region.

28. The light emitting device of claim 1, wherein the housing comprises a tubular structure.

29. The light emitting device of claim 1, wherein the housing comprises a bullet shape, a candle shape, a flare shape, a global shape, a reflector shape, a sign shape, or a tubular shape.

30. The light emitting device of claim 1, wherein the housing comprises a standard shape.

31. The light emitting device of claim 1, wherein the housing comprises a standard shape as defined by the American National Standards Institute (ANSI) or the International Electrotechnical Commission (IEC).

32. The light emitting device of claim 1, wherein the at least one end cap connector structure comprises a standard light bulb base.

33. The light emitting device of claim 1, further comprising:
a driver component configured to convert power from an alternative current (AC) input into a direct current (DC) output for driving the plurality of solid-state light emitters.

34. The light emitting device of claim 33, further comprising:
a dim control component in communication with one or more sensors, the dim control component configured to regulate current flow responsive to one or more inputs from the one or more sensors indicative of an environmental lighting condition.

35. The light emitting device of claim 33, further comprising:
a dim control component in communication with one or more sensors, the dim control component configured to regulate current flow responsive to at least one measurement indicative of change in luminosity.

36. The light emitting device of claim 33, further comprising:
a dim control component in communication with one or more sensors, the dim control component configured to regulate current flow responsive to at least one measurement indicative of change in line voltage.

37. The light emitting device of claim 33, further comprising:
a voltage component configured to determine a line voltage.

38. The light emitting device of claim 33, further comprising:
a first power regulator component configured to regulate an applied direct current (DC) and an applied direct current (DC) voltage to the plurality of solid-state light emitters.

39. The light emitting device of claim 33, further comprising:
a communication component configured to communicate with a remote component and to receive control information from the remote component.

40. The light emitting device of claim 33, further comprising:
a communication component configured to communicate with a remote component and to exchange one or more encryption keys with the remote component.

41. The light emitting device of claim 1, further comprising:
a driver component configured to convert power from an alternative current (AC) input into a direct current (DC) output for driving the plurality of solid-state light emitters.

42. The light emitting device of claim 1, further comprising:
an audio-activated control component operable to receive an audio input and to correlate the audio input to at least one control command for controlling at least one of an applied current or an applied voltage.

43. The light emitting device of claim 1, further comprising:
a speech recognition device including a speech control component configured to correlate speech input to at least one control command for controlling at least one of an applied current or an applied voltage.

44. The light emitting device of claim 1, wherein the plurality of solid-state light emitters includes one or more optical emitters.

45. The light emitting device of claim 1, wherein the plurality of solid-state light emitters includes one or more light-emitting diodes.

46. The light emitting device of claim 1, wherein the plurality of solid-state light emitters comprises a spaced-apart configuration to maximize heat diffusion.

47. The light emitting device of claim 1, wherein the plurality of solid-state light emitters comprises a spaced-apart configuration to maximize heat dissipation.

48. The light emitting device of claim 1, wherein the plurality of solid-state light emitters comprises a spaced-apart configuration to maximize thermal convection.

49. The light emitting device of claim 1, wherein the plurality of solid-state light emitters comprises a spaced-apart configuration to maximize thermal radiation.

50. The light emitting device of claim 1, further comprising:
a plurality of structural clips sized and dimensioned to support the plurality of solid-state light emitters within the housing.

51. The light emitting device of claim 1, further comprising:
a plurality of micropores proximate the at least one end cap connector structure.

52. The light emitting device of claim 1, further comprising:
a Wi-Fi repeater.

53. An integrated illumination and networking device, comprising:
one or more light emitting devices;
one or more network devices; and
an integrated illumination and networking component operably coupled to at least one of the one or more light emitting devices and the one or more network devices.

54. The integrated illumination and networking device of claim 53, wherein at least one of the one or more light emitting devices; at least one of the one or more network devices; and the integrated illumination and networking component are received within a housing.

55. The integrated illumination and networking device of claim 53, wherein the one or more network devices comprise at least one of an access node, a bridge, a gateway, a hub, a range extender, a repeater, a router, or a switch.

56. The integrated illumination and networking device of claim 53, wherein at least one of the one or more light emitting devices comprises a plurality of solid-state light emitters received within a housing.

57. The integrated illumination and networking device of claim 53, wherein the integrated illumination and networking component includes circuitry configured to communicate one or more control commands for operating the one or more light emitting devices and the one or more network devices.

58. The integrated illumination and networking device of claim 53, wherein the integrated illumination and networking component includes circuitry configured to communicate with at least one client device.

59. The integrated illumination and networking device of claim 53, wherein the integrated illumination and networking component includes circuitry configured to negotiate an authorization protocol and to exchange control information with a client device.
